(19) United States
(12) Patent Application Publication
(10) Pub. No.: US 2018/0140883 A1
(43) Pub. Date: May 24, 2018

(54) Wheelchair Training System

(71) Applicant: VIRO ROBOTICS COMPANY LIMITED, Shatin, Hong Kong (CN)

(72) Inventors: Kam Fai Michael TSUI, Hong Kong (CN); Kit Nga WONG, Hong Kong (CN)

(73) Assignee: VIRO ROBOTICS COMPANY LIMITED, Shatin, Hong Kong (CN)

(21) Appl. No.: 15/579,950

(22) PCT Filed: May 27, 2016
(86) PCT No.: PCT/IB2016/053112

§ 371 Date: Dec. 6, 2017

Related U.S. Application Data
(60) Provisional application No. 62/172,782, filed on Jun. 8, 2015.

(51) Int. Cl. A63B 21/005; A63B 71/00; A63B 24/00; A63B 71/06; A63B 22/20

(52) U.S. Cl. CPC A63B 21/0051; A63B 71/0054; A63B 24/0062; A63B 71/0622; A63B 24/0087; A61G 5/1086; A63B 2220/803; A63B 2230/062; A63B 2071/0625; A63B 2071/0072; A63B 2220/833; A63B 22/20

(57) ABSTRACT

A wheelchair training system that comprises: a platform (110) that receives the wheelchair; two elongated parallel rollers (250) that are mounted on the platform (110) and are in tangential contact with two rear wheels (150, 160) of the wheelchair such that the two rollers (250) spin when the two rear wheels (150,160) rotate; and a spinning resistance control system (300) mounted on the platform (110) includes a magnet (310) that moves in different positions so that an overlapping area between a magnetic field generated from the magnet (310) and end of the two rollers (250) varies due to the magnet (310) being moved to the different positions. The magnetic field of the magnet (310) induces an eddy current in the two rollers (250) and generates a resistive force against rotation of the two wheels (150,160).

### FIELD OF THE INVENTION

The present invention relates to a wheelchair training system that includes a platform, rollers, and a spinning resistance control system.

### BACKGROUND

Wheelchairs are an important transportation tool for people with walking problems. However, many of those people do not know how to operate a wheelchair properly. In particular, for complex or adverse road conditions, they would probably find it difficult to use their wheelchairs, and accidents sometimes occur as a result.

In view of the demand for how to use a wheelchair properly, a wheelchair training system is desired.

### BRIEF DESCRIPTION OF THE DRAWINGS

FIG. 1 shows a wheelchair training system in accordance with an example embodiment.

FIG. 2A shows a partial view of a wheelchair training system in which two rollers and a motion sensor are mounted on a platform, a roller disc is attached to an end of the roller and an encoder disc surrounds the roller disc in accordance with an example embodiment.

FIG. 2B shows a partial view of another embodiment of a wheelchair training system in which two rollers and a motion sensor are mounted on a platform, a roller disc is attached to an end of the roller and an encoder disc surrounds the roller disc in accordance with an example embodiment.

FIG. 3A shows a side view of rollers and spinning resistance control system in accordance with an example embodiment.

FIG. 3B shows the magnet of FIG. 3A moved upwardly in accordance with an example embodiment.

FIG. 4 shows a top view of rollers and spinning resistance control system in accordance with an example embodiment.

FIG. 5 shows another embodiment of magnet which rotates around an axis in order to adjust overlapping area between a magnetic field and a roller in accordance with an example embodiment.

FIG. 6A shows a shaft holder mounted on a platform in accordance with an example embodiment.

FIG. 6B shows magnets installed through an axis of the shaft holder of FIG. 6A in accordance with an example embodiment.

FIG. 7 shows a method to train a user in using a wheelchair in accordance with an example embodiment.

FIG. 8 shows a method of adjusting the resistive force in accordance with an example embodiment.

FIG. 9 shows an algorithm of operating a wheelchair training system in accordance with an example embodiment.

### SUMMARY OF THE INVENTION

One example embodiment is a wheelchair training system that includes a platform and two elongated parallel rollers and a spinning resistance control system. The platform receives the wheelchair. The rollers are mounted on the platform and are in contact with two rear wheels of the wheelchair such that the two rollers spin when the two rear wheels rotate. The spinning resistance control system is mounted on the platform and includes a magnet that moves in different positions so that an overlapping area between a magnetic field generated from the magnet and ends of the two rollers varies due to the magnet being moved to the different positions. The magnetic field of the magnet induces an eddy current in the two rollers and generates a resistive force against rotation of the two wheels. This resistive force varies as the magnet moves in the different positions.

Other example embodiments are discussed herein.

### DETAILED DESCRIPTION

Example embodiments relate to apparatus and methods that provide a wheelchair training system that includes a plurality of rollers and a spinning resistance control system.

An example embodiment includes a spinning resistance control system that provides a resistive force to a plurality of rollers so that the rollers transmit a retarding force to rotation of rear wheels of a wheelchair that stands on the rollers. The spinning resistance control system includes a magnet and a controlling element that moves the magnet to different positions in order to adjust an overlapping area between a magnetic field generated from the magnet and the rollers. The magnetic field can induce an eddy current in the rollers so that the resistive force is provided to the rotation of rollers. The resistive force varies as the magnet moves in different positions.

In one embodiment for example, the magnet is moved upward or downward vertically by adjusting the controlling element. When the magnet is lifted up, the overlapping area between the magnetic field and the rollers increases so that the resistive force against the rotation of rear wheels increases. As the magnet is pushed down by the controlling element, the overlapping area between the magnetic field and the rollers decreases and therefore the resistive force provided to the rotation of rear wheels reduces.

In an example embodiment, the magnet rotates around an axis, and such rotation adjusts the overlapping area between the magnetic field and the rollers. In another example, the axis around which the magnet rotates is mounted on a platform or a board and the axis is parallel to the shafts of the rollers.

The magnet can be one or more pieces of magnets. The rollers can be two elongated parallel rollers, four rollers, or another number of rollers. For example, two of the rollers are adapted to tangentially contact the left rear wheel of the wheelchair and two of the rollers are adapted to tangentially contact the right rear wheel of the wheelchair. The spinning resistance control system can be one or more sets of magnets and controlling elements, in which each set of magnets and controlling elements correspond and provide a resistive force to rotation of each roller.

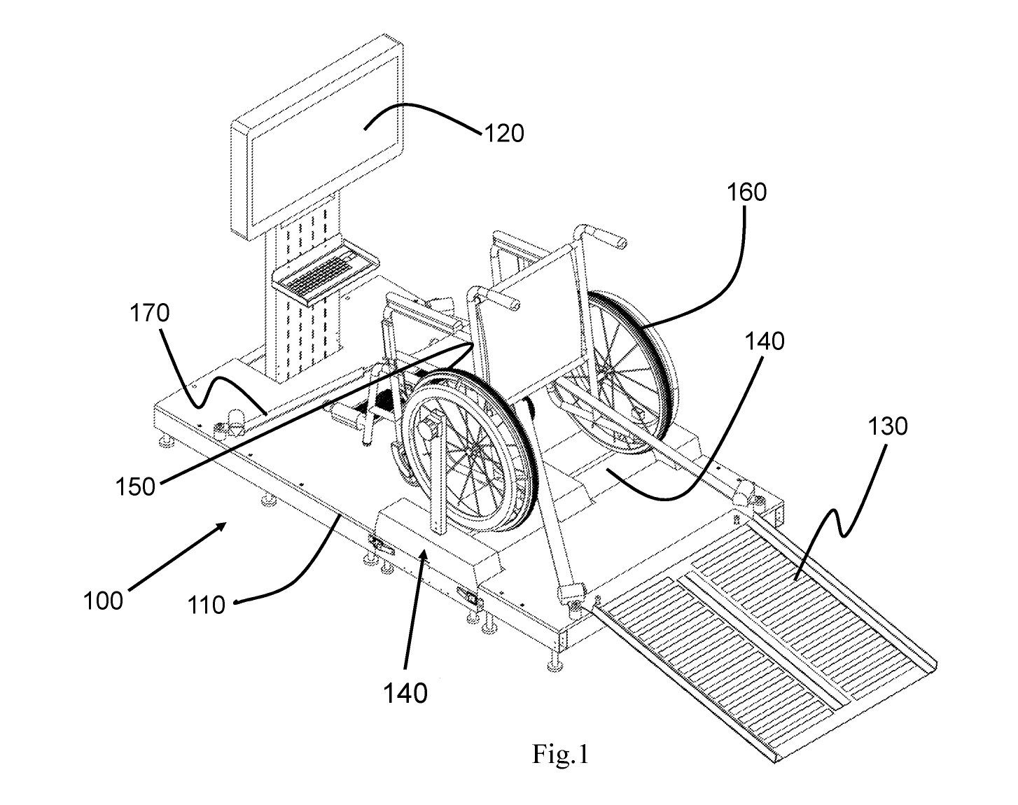

FIG. 1 shows a wheelchair training system 100 that includes a supporting platform 110 and a computer system 120 disposed on a first end of the supporting platform 110. A ramp 130 removably connects with a second end of the supporting platform 110. A number of rollers 140 are disposed on the supporting platform 110, in which each roller 140 is coupled to the supporting platform 110 in a tangential position relative to the rear wheels of the wheelchair. In an embodiment as shown in FIG. 1, there are four rollers in the training system in which two of the rollers are adapted to be tangentially in contact with the left rear wheel 150 of the wheelchair, and the remaining two rollers are adapted to be tangentially in contact with the right rear wheel 160 of the wheelchair.

The wheelchair training system further includes a plurality of safety belts 170 anchored on the supporting platform, as illustrated in FIG. 1. Each of the safety belts 170 is adapted to securely connect the wheelchair to the supporting platform. In an example embodiment, two safety belts 170 are anchored on the first end of the supporting platform 110 while the other two safety belts 170 are attached to the second end of the supporting platform 110. In an example embodiment, the safety belt 170 connects the frame of the wheelchair to the supporting platform 110. In another example embodiment, the safety belts 170 connect the upper part of the frame of the wheelchair to the supporting platform 110 to provide additional security to the wheelchair and prevent the wheelchair from flipping over. In other example embodiment, the safety belts 170 connect the lower part of the frame of the wheelchair to the supporting platform.

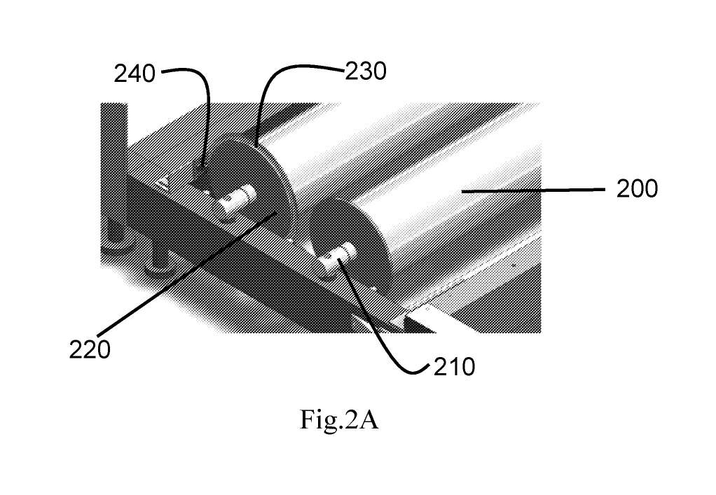

FIG. 2A shows rollers 200 mounted on a platform with a shaft 210 that contacts the platform. Each of the rollers 200 has a roller disc 220 attached to one end of the roller. An encoder disc 230 surrounds an edge of the roller disc 220. A motion sensor 240 is installed on the platform that monitors spinning of the rollers and in turn monitors rotation of rear wheels. For example, the motion sensor 240 monitors velocity and/or direction of the rotation of the rear wheels in cooperation with the encoder disc. In an example embodiment, the roller disc is conductive and can be made of various conductive materials, such as aluminum, iron, etc.

FIG. 2B shows another embodiment of two rollers 250 mounted on a platform 255 with each roller having a shaft 260 that contacts to the platform 255 via a pillow block bearing 265. Each of the rollers 250 has a roller disc 270 attached to one end of the roller. An encoder disc 280 surrounds an edge of one of the roller discs. A motion sensor 290 is installed on the platform that monitors spinning of the rollers and in turn monitors rotation of rear wheels. For example, the motion sensor 290 monitors velocity and/or direction of the rotation of the rear wheels in cooperation with the encoder disc. In an example embodiment, the roller disc is conductive and can be made of various conductive materials, such as aluminum, iron, etc.

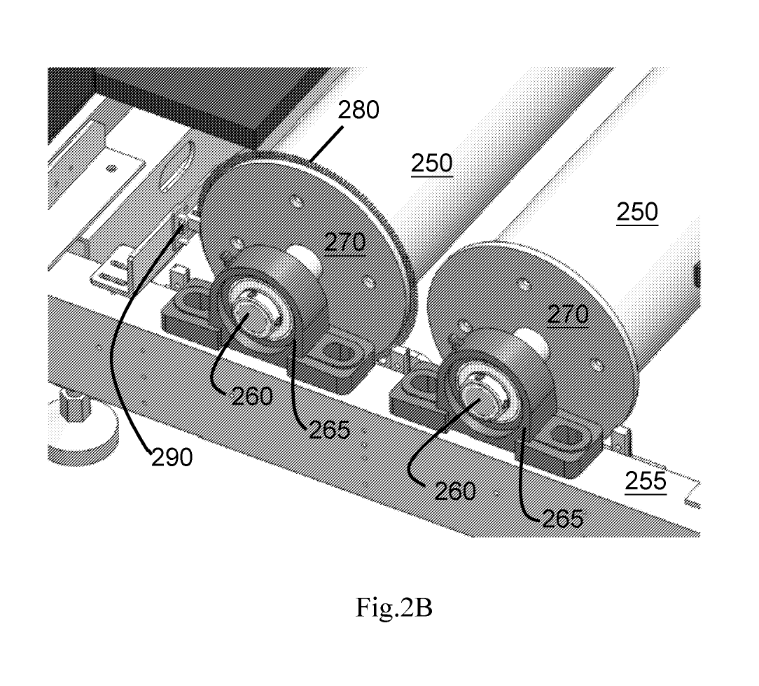

FIG. 3A shows a spinning resistance control system 300 that includes a magnet 310 and a controlling element 320. In an example embodiment, the magnet 310 is a rectangular strip completely or substantially covering the two rollers or roller discs 330. For example, a length of the magnet is no less than a sum of diameters of the two rollers or roller discs 330.

Each of the two ends of the magnet 310 is respectively and movably installed onto a Linear Motion (LM) guide 340. The LM guide has two components of a track 350 and a block 360. The track 350 of the LM guide is fixed on a supporting platform, while the magnet 310 is fixed on the block 360 so that when the block 360 slides along the track 350, the magnet 310 can slide upwardly and downwardly along a direction of arrow A.

A controlling element 320 is disposed to connect with the magnet 310 such that it can drive the upward and downward motion of the magnet 310 along the arrow A as shown in FIG. 3A. A user can move the magnet 310 upwardly and downwardly by adjusting the controlling element 320 without crouching down.

For example, as shown in FIG. 3B, a user can pull the controlling element to lift up the magnet along the direction of arrow μl so that the magnet covers more area of the rollers. Therefore, the overlapping area between the rollers and the magnetic field will be increased and in turn the resistive force against the rotation of the rollers will be enhanced.

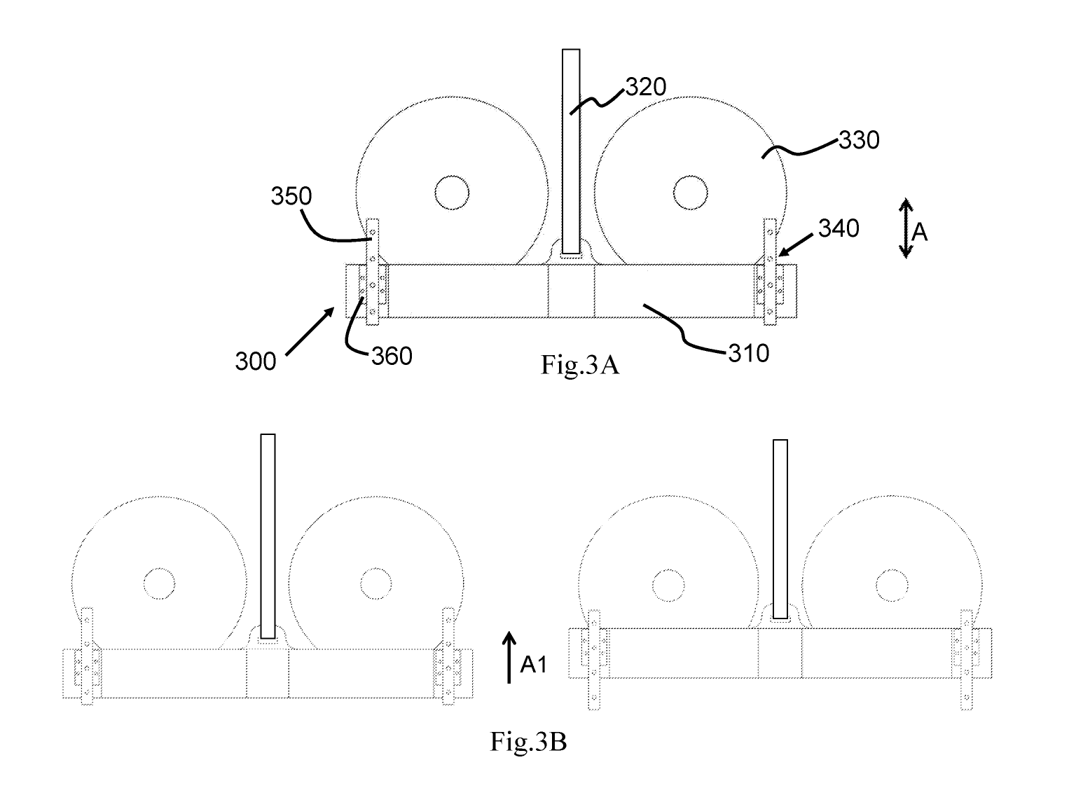

FIG. 4 shows a spinning resistance control system 400 that includes a magnet 410 and a controlling element 420. By way of example, the controlling element 420 can be a rope, a wire, or a rod, etc. Rollers 430 are supported by a platform via shafts 440. A roller disc 450 is attached to an end of the roller 430. The roller disc 450 has a larger diameter than that of the roller 430. The length of the magnet 410 is more than a sum of the diameters of two roller discs 450.

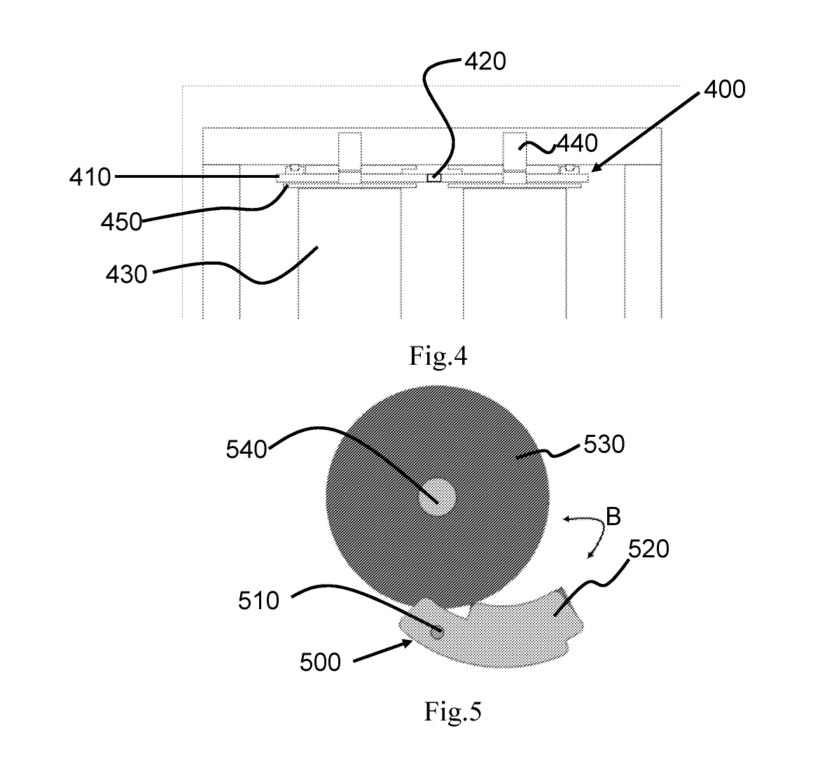

FIG. 5 shows another embodiment of a spinning resistance control system 500 that includes an axis 510 and a magnet 520 and a controlling element (not shown). By way of example, the axis 510 is parallel to a shaft 540 of a roller 530. The magnet 520 rotates around the axis 510 along the direction of arrow B, i.e. clockwise or anti-clockwise rotation, so that the overlapping area between a magnetic field and the roller 530 will be changed. Therefore, resistive force against the rotation of roller 530 will be varied.

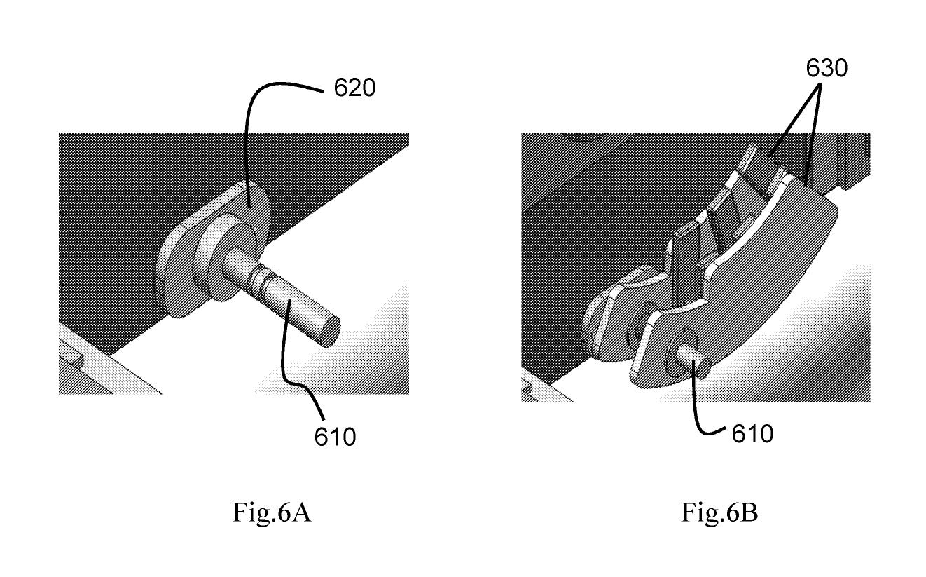

FIG. 6A shows an axis 610 is fixed on a platform by a shaft holder 620. As shown in FIG. 6B, two pieces of magnets 620 are rotatable around the axis 610 to overlap some area of a roller or roller disc (not shown in FIGS. 6A and 6B). The rotational movement of the magnets 620 are adjusted by a controlling element (not shown).

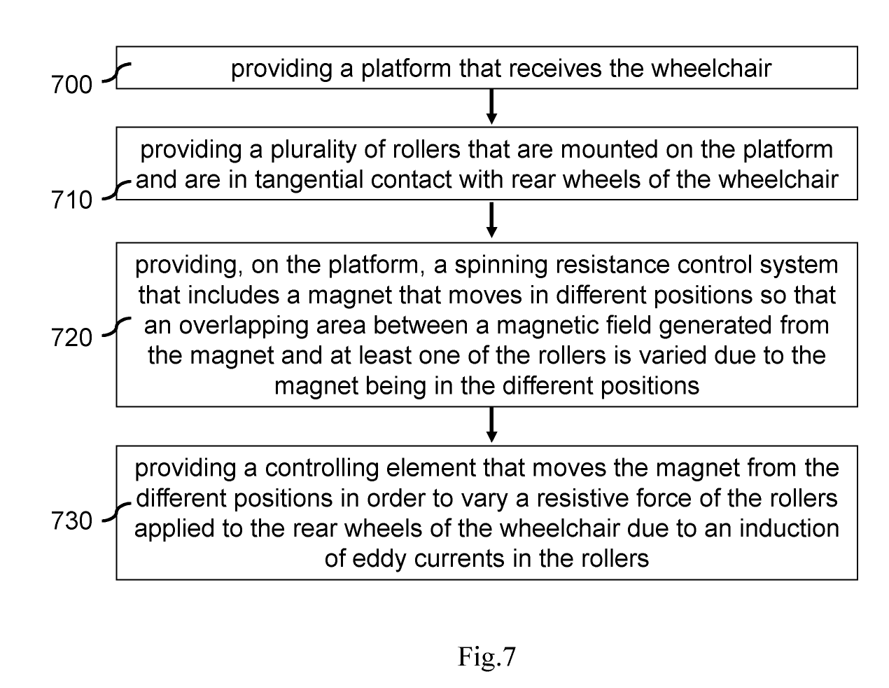

FIG. 7 shows a method to train a user in using a wheelchair in accordance with an example embodiment.

According to block 700, a platform that receives a wheelchair is provided. In one example, the platform can be a board or other structure.

According to block 710, a plurality of rollers that are mounted on the platform and are in tangential contact with rear wheels of the wheelchair are provided.

According to block 720, a spinning resistance control system is provided. The spinning resistance control system includes a magnet that moves in different positions so that an overlapping area between a magnetic field generated from the magnet and at least one of the rollers is varied due to the magnet being in the different positions. In an example embodiment, one or more spinning resistance control system are provided, in which each system controls rotation of each roller.

According to block 730, a controlling element is provided that moves the magnet from different positions in order to vary a resistive force of the rollers applied to the rear wheels of the wheelchair due the an induction of eddy currents in the rollers. In an example embodiment, the controlling element is attached to the middle portion of the magnet.

In an example embodiment, a ramp is provided that allows a convenient access for a trainee or a therapist to drive the wheelchair into or out of the platform.

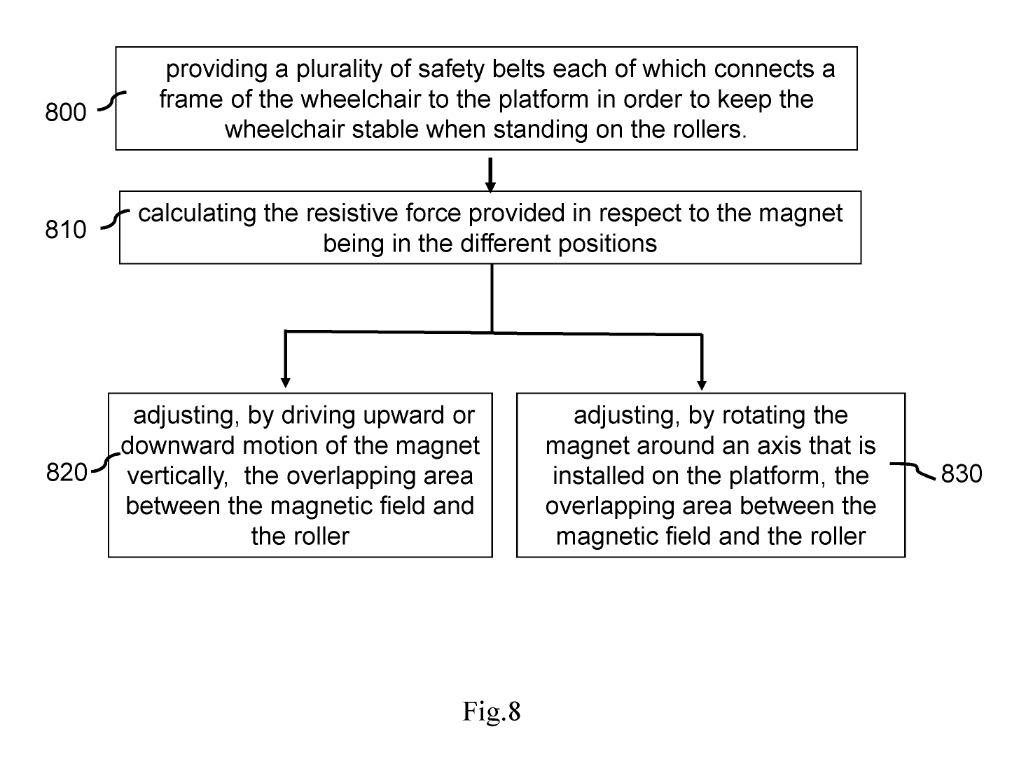

FIG. 8 shows a method to adjust a resistive force in accordance with an example embodiment.

According to block 800, a plurality of safety belts are provided, each of which connects a frame of the wheelchair to the platform in order to keep the wheelchair stable when standing on the rollers. In an example embodiment, safety belts can be four-points that connect the wheelchair with four corners of the platform.

According to block 810, the resistive force provided in respect to the magnet being in the different positions is calculated.

In an example embodiment, an indicator that indicates scales of the resistive force is provided. The indicator is connected to the controlling element.

According to block 820, the overlapping area between the magnetic field and the roller is adjusted by driving upward or downward motion of the magnet vertically.

According to block 830, the overlapping area between the magnetic field and the roller is adjusted by rotating the magnet around an axis that is installed on the platform.

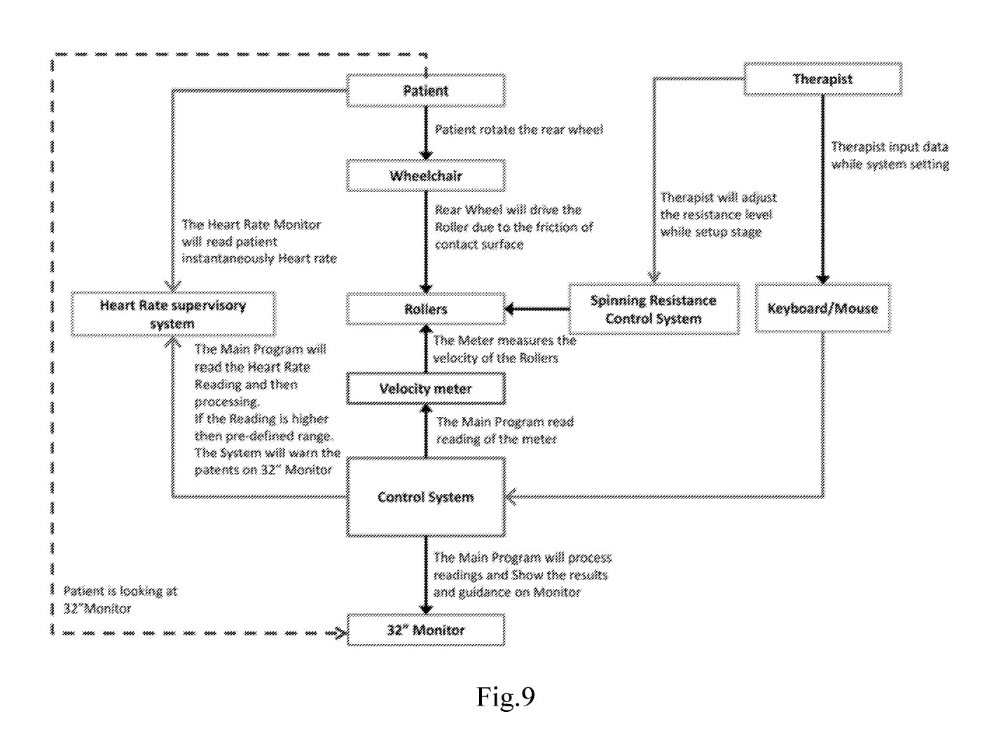

FIG. 9 shows operation of a wheelchair training system according to an example embodiment.

First, a therapist pushes the wheelchair to the supporting perform and parks the wheelchair in a predetermined position on the supporting platform; in an example embodiment, the wheelchair is parked in the predetermined position in which the real wheels of the wheelchair are in tangential contact with the roller. The therapist then fixes the wheelchair by the safety belts. Before the start of the training, the therapist inputs data of the person to be trained (trainee), such as age and name of the trainee, and training time, and pre-sets a resistance level by adjusting the position of magnet of spinning resistance control system. The resistance level correlates with the resistive force exerted on the rollers by the movement of the magnet respective to the roller. This resistive force will in turn translate into a retarding force applicable to trainee when the trainee rotates the rear wheels of the wheelchair.

For example, when a therapist adjusts the controlling element to lift up the magnet, the overlapping area between the magnetic fields generated by the magnet and the roller disc would be increased. According to the Lenz's Law, the Eddy Current is induced within the roller disc if it is moving in a magnetic field, which is generated by magnet. Thus a magnetic force will be applied on the roller disc which is opposing the rotation of the roller disc. The resistive force exerted on the roller is thus resulted. The more overlapping area between the magnetic fields generated by the magnet and the roller disc is, the higher the resistance on the roller will be resulted.

In another example embodiment of the spinning resistance control system, the magnet is rotatable around the axis to change the overlapping area between the magnetic fields generated by the magnet and the roller disc, such that the resistive force exerted on the roller disc can also be varied.

In an example embodiment, the variation of the resistance can be continuously. In one example embodiment, the controlling element can be provided with an indicator so that the therapist can be aware of the strength of the resistive force applied onto the rollers so as to facilitate modification of the treatment course. Further, different strengths of the resistance may be used to simulate distinct road conditions. For example, in a “scale 1 condition”, a certain amount of resistive force (in other words, the amount of overlapping area between the magnetic fields generated by magnet and the roller disc) is applied that in turn represents an uphill condition with gentle slope, while in a “scale 2 condition”, more resistive forces are applied that refers to uphill condition with a steeper slope.

After the required parameters are input to the system, the training begins. The trainee then rotates the rear wheels which will drive the rollers to rotate due to the friction of contact surface. The velocities of the rollers is measured by the motion sensor in cooperation with encoder disc. Upon reading the measured velocities, the main program of the control system further processes the values, where the results and guidance are shown on a monitor to the trainee and therapist. In an example embodiment, the guidance can be game instruction of virtual reality interactive software installed in the computer system.

Meanwhile, the heart rate of the trainee can be instantaneously monitored by a heart rate supervisory system. Upon reading the measured heart rates, the main program of the control system evaluates the value to determine if the value is higher than a pre-defined threshold value. If the value is higher than the threshold value, the control system gives a warning to the trainee by, for example, displaying a warning message on the monitor or providing an audio alert.

The example embodiments of the present invention are thus fully described. Although the description referred to particular embodiments, it will be clear to one skilled in the art that the present invention may be practiced with variation of these specific details. Hence this invention should not be construed as limited to the embodiments set forth herein.

As used herein, an “eddy current” is loops of electrical current induced within conductors by a changing magnetic field in the conductor due to Faraday's law of induction.

As used herein, an “encoder” is a device, circuit, transducer, software program or algorithm that converts information from one format or code to another.

What is claimed is:

1. A wheelchair training system that trains a person in using a wheelchair, the system comprising:
a platform that receives the wheelchair;
two elongated parallel rollers that are mounted on the platform and are in contact with two rear wheels of the wheelchair such that the two rollers spin when the two rear wheels rotate; and
a spinning resistance control system mounted on the platform that includes a magnet that moves in different positions so that an overlapping area between a magnetic field generated from the magnet and ends of the two rollers varies due to the magnet being moved to the different positions,
wherein the magnetic field of the magnet induces an eddy current in the two rollers and generates a resistive force against rotation of the two wheels, and the resistive force varies as the magnet moves in the different positions.

2. The wheelchair training system of claim 1, wherein the magnet is a rectangular strip and length of the magnet is no less than a sum of diameters of the two rollers.

3. The wheelchair training system of claim 1, wherein the magnet moves upward or downward vertically.

4. The wheelchair training system of claim 1, wherein the spinning resistance control system further includes a controlling element that is attached to middle portion of the magnet and controls movement of the magnet to the different positions.

5. The wheelchair training system of claim 1, wherein the magnet rotates around an axis that is connected to the platform and a rotation of the magnet changes the overlapping area between the magnetic field and the end of the roller.

6. The wheelchair training system of claim 1 further comprising:
a plurality of safety belts each of which connects a frame of the wheelchair to the platform in order to keep the wheelchair stable when standing on the rollers.

7. A wheelchair training system, comprising:
two rollers parallel to each other that are disposed on a platform, that support rear wheels of a wheelchair, and that provide a resistive force to a movement of the rear wheels of the wheelchair;
a magnet that generates a magnetic field and moves to different positions where a strength of the magnetic field applied to the two rollers changes due to changes in an overlapping area between the magnetic field and the two rollers; and
a controlling element that moves the magnet to the different positions in order to change the resistive force provided to the movement of the rear wheels of the wheelchair,
wherein the magnetic field of the magnet induces an eddy current in the two rollers and generates the resistive force.

8. The wheelchair training system of claim 7, wherein a conductive roller disc is attached to the end of the roller, and the eddy current is generated in the roller disc so that the roller disc provides the resistive force to the movement of the rear wheel.

9. The wheelchair training system of claim 8 further comprising:
at least one motion sensor that is installed on the platform and monitors the movement of the rear wheel.

10. The wheelchair training system of claim 9, wherein edge of the conductive roller disc is surrounded by an encoder disc and the motion sensor detects velocity or direction of the movement of the rear wheel by the encoder disc.

11. A method to train a user in using a wheelchair, the method comprising:
providing a platform that receives the wheelchair;
providing a plurality of rollers that are mounted on the platform and are in tangential contact with rear wheels of the wheelchair;
providing, on the platform, a spinning resistance control system that includes a magnet that moves in different positions so that an overlapping area between a magnetic field generated from the magnet and at least one of the rollers is varied due to the magnet being in the different positions; and
providing a controlling element that moves the magnet from the different positions in order to vary a resistive force of the rollers applied to the rear wheels of the wheelchair due to an induction of eddy currents in the rollers.

12. The method of claim 11 further comprising:
providing a plurality of safety belts each of which connects a frame of the wheelchair to the platform in order to keep the wheelchair stable when standing on the rollers.

13. The method of claim 11 further comprising:
calculating the resistive force provided in respect to the magnet being in the different positions.

14. The method of claim 11 further comprising:
adjusting, by driving upward or downward motion of the magnet vertically, the overlapping area between the magnetic field and the roller.

15. The method of claim 11 further comprising:
adjusting, by rotating the magnet around an axis that is installed on the platform, the overlapping area between the magnetic field and the roller.
